(19) United States
(12) Patent Application Publication
(10) Pub. No.: US 2005/0114379 A1
(43) Pub. Date: May 26, 2005

(54) Audio/video service quality analysis of customer/agent interaction

(76) Inventor: Howard M. Lee, Seattle, WA (US)

Correspondence Address: Mark S. Peloquin;PELOQUIN, PLLC, Suite 4100, 800 Fifth Avenue, Seattle, WA, 98104-3100, US

(21) Appl. No.: 10/721,704

(22) Filed: Nov. 25, 2003

(51) Int. Cl. G06F 17/00

(52) U.S. Cl. 707/102

(57) ABSTRACT

A method includes receiving a storable representation of an audio/video interaction between an agent of a business and a customer. The storable representation is analyzed to determine the service quality provided to the customer by the agent. Analysis data associated with the audio/video interaction is generated. An apparatus includes a storage device configured to receive and store the storable representation of the audio/video interaction. A report generator is configured to generate analysis data, which is fed back to the agent and represents the quality of service rendered by the agent to the customer. The agent can be informed of at least one agent performance element that was well performed and at least one agent performance element that could be performed even better.

### BACKGROUND OF THE INVENTION

1. Field of Invention

The invention relates generally to measuring and improving business performance, and more specifically to apparatuses and methods used to measure and improve the quality of the customer/agent interaction.

2. Art Background

Businesses interact with a plethora of customers on a daily basis across the world in order to conduct commerce in the modern age. A given business experiences its own universe of customer interactions, which are necessary to maintaining a healthy and thriving state of business-customer relationships; such a state of business-customer relationships is necessary and vital to ensure the success of the business.

In order to interface with the customers, businesses utilize people (agents) to interact with their customers in a variety of venues. The drive-up window at a fast food restaurant, the checkout counter in a grocery store or restaurant, a customer service counter in a department store, and a service counter in a bank are just some of examples of the many face-to-face venues that businesses use to interact with their customers.

New business personnel are typically trained by experienced business personnel and after a period of time the new business personnel participate unsupervised in customer interactions. Supervisors return for periodic checks; however, after a period of time supervisors only return if a problem occurs that rises above a threshold sufficient to commend their attention. Problems that do not rise above the threshold go undetected and can have a negative effect on the sales (or lack thereof flowing from the impaired customer interactions.

Additionally, some businesses have adopted the contact center model to provide personal service to the customers via teams of agents that engage in interactions with customers. Currently, customers commonly use the telephone and/or email as a means of contacting a business, such an existing center staffed with agents to field calls from customers is commonly called a call center, referred to herein as a legacy center(s).

Legacy centers can vary in size from small units containing several agents to large units containing teams of agents numbering into the hundreds or even thousands. Often the legacy centers are large and require significant resources to staff, manage, and train the agents that comprise the legacy center. Legacy centers are managed by one or more managers whose jobs include both solving the complex customer problem, which presents questions beyond the authority of the agent to resolve, to supervising the agent's interaction with the customers so that the quality of service provided to the customers can be monitored and hopefully improved.

Assessing the quality of service provided to the customers by the legacy center agents has grown increasingly more difficult as legacy centers have increased in size. An agent handles many calls and/or emails a day; however, only a small fraction of the calls and/or emails fielded by an agent are ever monitored by a legacy center supervisor. Typically, legacy center agent performance is measured only once a week, at an agent level. This low frequency rate of monitoring does not provide an adequate measure of the agent's performance and the quality of service provided to the customer. Neither can the legacy center supervisor increase the sales rate of the agents or the overall return on investment with respect to the legacy center.

Additionally, existing legacy centers, designed around a telephone call and/or an email to provide a medium for an interaction between a customer and an agent are not sufficient to capture the totality of the interaction between the customer and the agent since advances in technology have created other mediums of communication between the customer and the agent.

What is needed are affordable processes and systems for face-to-face venues and business contact centers, that are scalable to any size business, which can also improve the performance of the agents, the business processes, and the customer interactions.

### BRIEF DESCRIPTION OF THE DRAWINGS

The invention may best be understood by referring to the following description and accompanying drawings that are used to illustrate embodiments of the invention. The invention is illustrated by way of example in the embodiments and is not limited in the figures of the accompanying drawings, in which like references indicate similar elements.

FIG. 1 illustrates system architecture for audio/video customer-contact analysis according to one embodiment of the invention.

FIG. 2 illustrates a non face-to-face audio/video interaction according to one embodiment of the invention.

FIG. 3 illustrates face-to-face audio/video interaction according to one embodiment of the invention.

FIG. 4 illustrates system architecture for customer/agent interaction analysis and improvement, employing wage attenuation, according to one embodiment of the invention.

FIG. 5 illustrates one embodiment of contact center audio/video interaction monitoring.

FIG. 6 displays one embodiment of a score sheet.

FIG. 7 contains a continuation of the score sheet from FIG. 6.

FIG. 8 contains a continuation of the score sheet from FIG. 7.

FIG. 9 illustrates a flow diagram for audio/video interaction analysis and feedback according to one embodiment of the invention.

FIG. 10 is a training flow chart according to one embodiment of the invention.

FIG. 11 illustrates an integration of calibration types, according to one embodiment of the invention.

FIG. 12 is one embodiment of an Internet based agent level evaluation feedback tool.

FIG. 13 illustrates real-time contact center monitoring according to one embodiment of the invention.

FIG. 14 illustrates a flow diagram for audio/video interaction analysis corresponding to FIG. 13.

FIG. 15 illustrates a flow diagram employing a data base, according to one embodiment of the invention.

FIG. 16 illustrates an example of increased profitability according to one embodiment of the invention.

### DETAILED DESCRIPTION

In the following detailed description of embodiments of the invention, reference is made to the accompanying drawings in which like references indicate similar elements, and in which is shown by way of illustration, specific embodiments in which the invention may be practiced. These embodiments are described in sufficient detail to enable those of skill in the art to practice the invention. In other instances, well-known circuits, structures, and techniques have not been shown in detail in order not to obscure the understanding of this description. The following detailed description is, therefore, not to be taken in a limiting sense, and the scope of the invention is defined only by the appended claims.

Apparatuses and methods are described to allow businesses to monitor and evaluate audio/video interactions between their customers and their agents. In one embodiment, profitability can be increased by monitoring a business's contact center processes at high frequency with special feedback provided to the business's contact center. In one embodiment, high frequency monitoring is achieved by employing geographic wage attenuation coupled with language fluency between the agent-customer contact and the analyst.

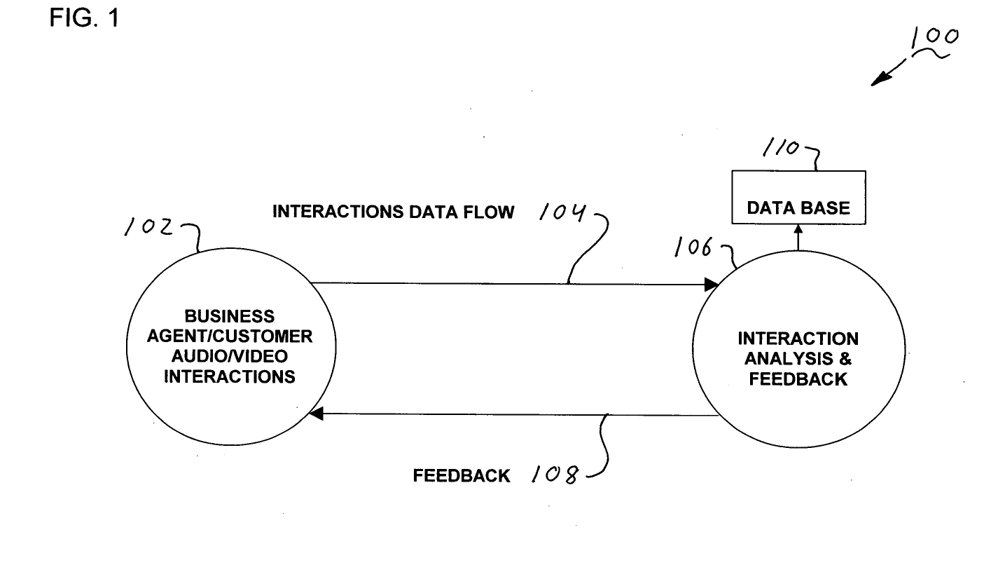

FIG. 1 illustrates system architecture for audio/video customer-contact analysis generally at 100 according to one embodiment of the invention. With reference to FIG. 1, audio/video interactions occur between customers of a business and agents of the business at 102. These audio/video interactions are transmitted in the form of data 104 to analysts at 106. Analysts analyze the audio/video interactions at 106 and provide feedback 108 to the business and the agents. Within the context of this description, “agent” is used broadly to include any person authorized by the business to interact with the customers of the business. Therefore, it is recognized that “agent” is not limited to the strict legal meaning of the word. Used in this context, “agent” encompasses private contractors, external contact center personnel, which can supply services to a business under contract, and employees of the business. Analysis of the audio/video interactions results in data which are compiled in data base 110. Uses of these data will be described in conjunction with the figures that follow below. Audio/video interactions between customers and agents can be in a non face-to-face and a face to face format.

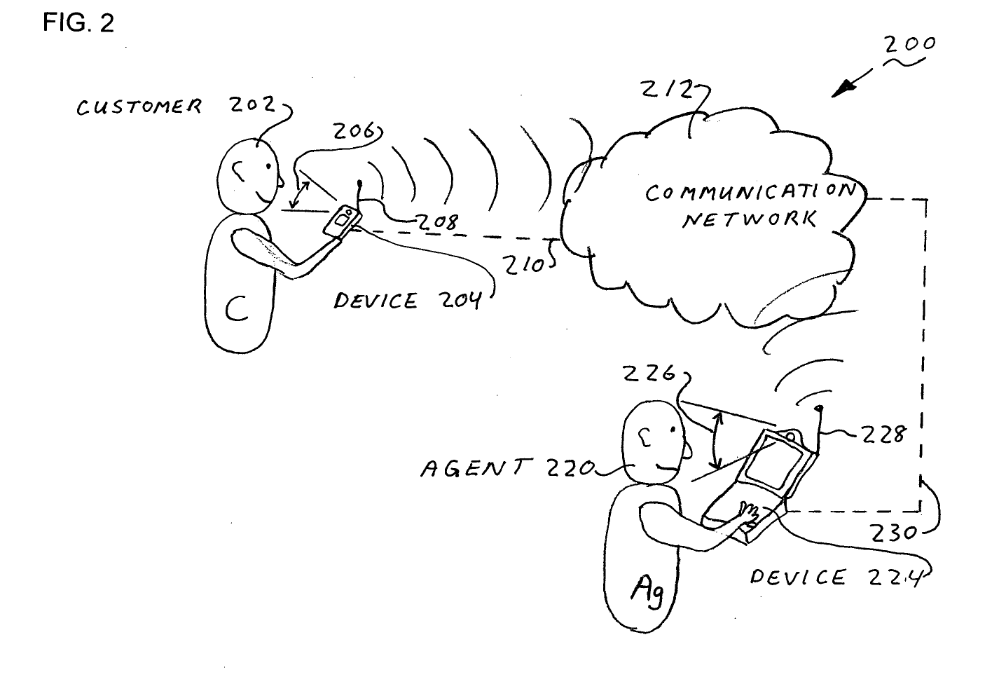

FIG. 2 illustrates a non face-to-face audio/video interaction according to one embodiment of the invention. With reference to FIG. 2, a customer 202 uses a device 204 to communicate with an agent 220 of a business (video telephony). The device 204 can be configured with a means for wireless communication 208. Similarly, the agent's device 224 can be configured with a means for wireless communication 228. Alternatively, both the device 204 and/or the device 224 can be connected to a communications network 212 with physical connections indicated by 210 and 230, respectively. Both devices 204 and 224 can be devices configured for use with an analog telephone line or the devices can be configured for use with an ISDN or an Internet Protocol (IP) network. Without limitation to the teachings presented herein, the devices can be connected to communications network 212 with, for example an analog telephone line, an Ethernet line, a wireless network, for example a network according to the 802.11(a) or 802.11(b) standard, or any other suitable communications network.

Device 204 can be, or can be configured from, a personal data assistant (PDA) equipped with a video camera and microphone. Alternatively, device 204 can be, or can be configured from, a tablet computer, a wearable computer, a lap-top computer, a desk-top computer, or a special purpose audio/video system. Such a device will capture audio and video of the customer 202 during an interaction with the agent. A video camera built into device 204 will have a field of view indicated generally by 206. The agent's device 224 can be equipped with a video camera and microphone to capture and audio and the video of the agent during the interaction with the customer 202. Similar to the customer's device, the video camera in the agent's device will have a field of view indicated approximately by 226. During the audio/video interaction, the agent will see the customer on the data display of device 224 and the customer will see the agent on the data display of device 204; thereby, providing a level of personal connection greater than what is achievable by an audio or email medium alone.

Many different video enabled devices can be used to capture the audio/video interaction, which is the subject of analysis by analysts in 106 (FIG. 1); the present invention is not limited by the choice of the device used to capture the audio/video interaction. Alternatively, the device 204 can be a video telephone such as the VIZUFON® video phone configured for use with an analog telephone line. Alternatively, the device can be a Maia® video telephone configured for use with an ISDN or IP network. The agent's device 204 can be configured to receive audio/video input from a variety of sources such as the VIZUFON® video phone as well as other video enabled devices such as the Maia® video telephone or it can be a VIZUFON® or Maiaevideo telephone. The agent's device 224 can be, or can be configured from, a video telephone, a desktop computer, a laptop computer, a tablet computer, a wearable computer, a personal data assistant (PDA), workstation or special purpose device configured to accept input from a variety of video enabled devices. Examples of video enabled devices provided herein are provided only for illustration; the present invention is not limited to a particular video enabled device. Audio-video interactions between a customer and an agent can be acquired in different ways, such as in the non face-to-face interactions described above and also in face-to-face interactions.

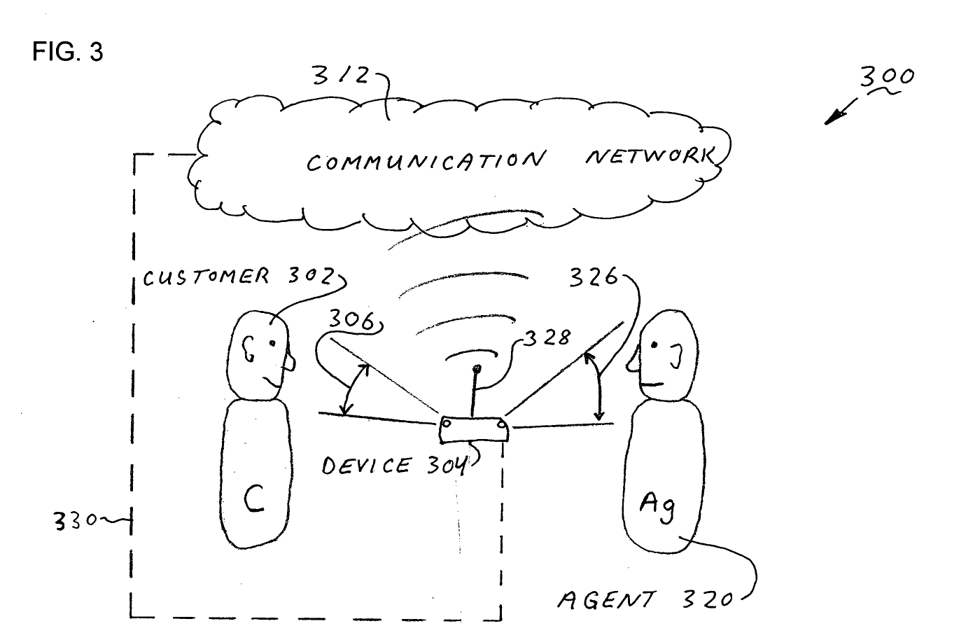

FIG. 3 illustrates a face-to-face audio/video interaction according to one embodiment of the invention. With respect to FIG. 3, a customer 302 is proximate to an agent 320 during an audio/video interaction. Face-to-face audio/video interactions can occur in a variety of venues, such as a checkout counter in a restaurant, a service counter in a bank, a checkout counter in a grocery store, a drive-up window at McDonalds, a customer service counter, etc. During the interaction between the customer and the agent a device 304 captures the audio and video aspects of the interaction. In one embodiment, the device 304 can be configured with two video cameras. One video camera having an aperture 306 pointed at the customer 302 and the other video camera having an aperture 326 pointed at the agent 320. The output of the device can be transmitted wirelessly via 328 to communication network 312 or by physical connection 330.

Alternatively, device 304 could be positioned such that one video camera is used to capture both the customer and the agent. In yet another configuration, device 304 could be configured as two separate devices, one device to capture the customer and the other device to capture the agent. Many hardware configurations are possible; the present invention is not limited by the hardware configuration used to capture the audio and video comprising the interaction between the customer and the agent.

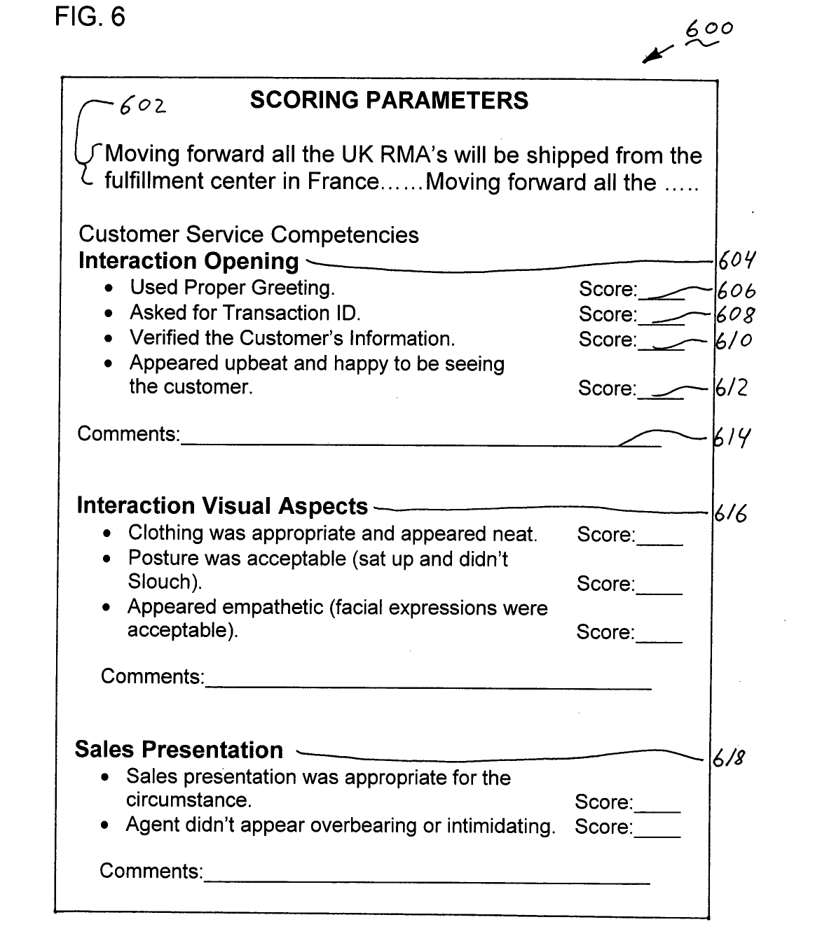

With reference to FIG. 1, audio/video interactions captured through non face-to-face agent/customer interactions (FIG. 2) and face-to-face agent/customer interactions (FIG. 3) are analyzed by analysts at 106 (FIG. 1). According to one embodiment, the analysis of the audio/video interactions will be described more fully with reference to FIGS. 6, 7, and 8 below.

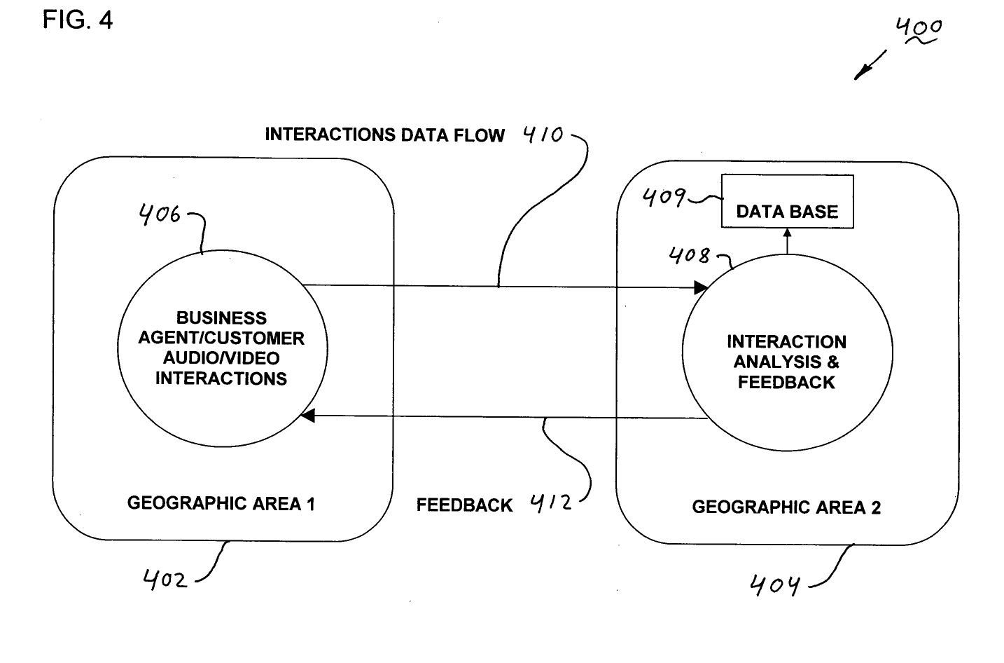

FIG. 4 illustrates system architecture for customer/agent interaction analysis and improvement, employing wage attenuation, according to one embodiment of the invention. With reference to FIG. 4, geographic wage attenuation is shown generally at 400. A first geographic area 1 is indicated at 402, wherein wages are high relative to a second geographic area 2 indicated generally at 404. Geographic area 402 and geographic area 404 are connected by a communication network that allows the transmission of information between the two geographic areas. Both geographic areas share at least one language in common and a differential in wages exists between the first and second geographic areas. For example, in one embodiment, geographic area 402 corresponds to the United States (US), geographic area 404 corresponds to India and the language shared in common is English. For a similar job, wages are higher in the US than wages are for the similar job in India; thereby, establishing geographic wage attenuation between the two distinct geographic areas.

As used in this description, sharing a language in common does not imply that the language is shared across the whole population of the geographical area. It is sufficient that a number of people, however small, can be found within the geographical area where the analysis of the customer contact is performed which shares the language in common with a number of people in the second geographical area. No constraint is placed on the number of people in either geographical area.

In one example, wages in the US are $20 US per hour and wages in India can be $4 US per hour for the same type of job. Wage attenuation will be defined as follows: wage attenuation equals the wages in geographic area 2 divided by the wages in geographic area 1. In the previous example, the wage attenuation (0.2) is arrived at by dividing $4 by $20: 0.2=(4/20). Geographic area 1 or the first geographic area is the area where the business's customers are located and possibly the business's agents are located; however, all of the business's customers and/or agents need not be located in geographic area 1. Geographic area 2 or the second geographic area is the area where the analysis of the customer interaction occurs.

In another embodiment, geographic area 402 can correspond to Canada, England or Australia. Some examples of geographic area 404 can include, but are not limited to, countries such as Botswana, Kenya, Liberia, Nigeria, South Africa, Swaziland, Tanzania, the Philippines, and Fiji, where the language in common is English. In another embodiment, geographic area 402 can correspond to France. Some examples of geographic area 404 can include, but are not limited to, countries such as Algeria, Rwanda, Senegal, and Haiti, where the language in common is French. In another embodiment, geographic area 402 can correspond to the United States. Some examples of geographic area 404 can include, but are not limited to, countries such as Argentina, Dominican Republic, Ecuador, El Salvador, Equatorial Guinea, Republic of the Congo, Mexico, Nicaragua, Panama, and Uruguay, where the language in common is Spanish. No limitation is placed on the particular geographic areas comprising the geographic wage attenuator or the language shared in common between the two geographic areas. In one or more embodiments, of the invention, a geographic area is a general area and need not be confined to the boundaries of specific countries as named herein. The geographic area can be a general region and can include a part of a country or a part of more than one country.

Located within geographic area 402 are one or more businesses having agents or teams of agents interacting with customers of the business, indicated generally at 406. These interactions can be face-to-face interactions or non face-to-face interactions as previously described. Many types of agent-customer audio/video interactions can be analyzed with the apparatuses and methods taught herein. Such examples include, but are not limited to, inbound sales calls (to make and change reservations and sell tickets for travel on airlines, trains, boats, etc.), reservations for dinner, salon appointments, sales at drive-up windows, interactions at customer service counters, etc. Other audio/video interactions include, technical support calls subsequent to the purchase of a product or service, including warranty support issues, etc. Calls to rent products or services, such as automobiles, clothing, etc. The present invention is not limited by the type of agent-customer audio/video interaction engaged in by a business. The audio/video interactions can consist of the audio and video of the customer and agent along with accompanying email and/or data related to the interaction.

The customers need not be confined to geographic area 402 but can be located in a variety of geographic areas other than 402 and 404. The agent/customer audio/video interaction data flow 410 proceeds from geographic area 402 to geographic area 404 by means of a communication network. The agent/customer audio/video interaction data flow is analyzed at 408 in geographic area 404. In one embodiment, analysts located in geographic area 404 analyze an agent's audio/video interactions with customer(s) at a rate of at least one interaction per agent per day to create a data base 409. In another embodiment, the agent's audio/video interactions are analyzed at a rate sufficient to provide a statistically relevant sample of the interaction data set. Special uses of the data base 409 will be described in more detail below with reference to the figures that follow.

Feedback 412 flows from geographic area 404 to geographic area 402 and is communicated to the business's agents. Feedback 412 comprises the results of scoring the agent's audio/video interaction with a customer and is used to improve the agent's performance; thereby, increasing the business's profitability. Feedback 412 will be described more fully below with reference to the figures that follow.

The frequency at which an agent's audio/video interactions are analyzed can be controlled by either the business within 406 or by the analysts within 408. Typically, the agent's audio/video interactions with customers will be analyzed at approximately a rate of one audio/video interaction per agent per day, indicated by X or a statistically relevant sample size based on the requirements of a business. In some embodiments, the analysis rate can be greater and will be indicated by a number preceding the X. For example, analyzing 4 audio/video interactions per agent per day would be indicated by 4X. Alternatively, X can represent a general sample frequency.

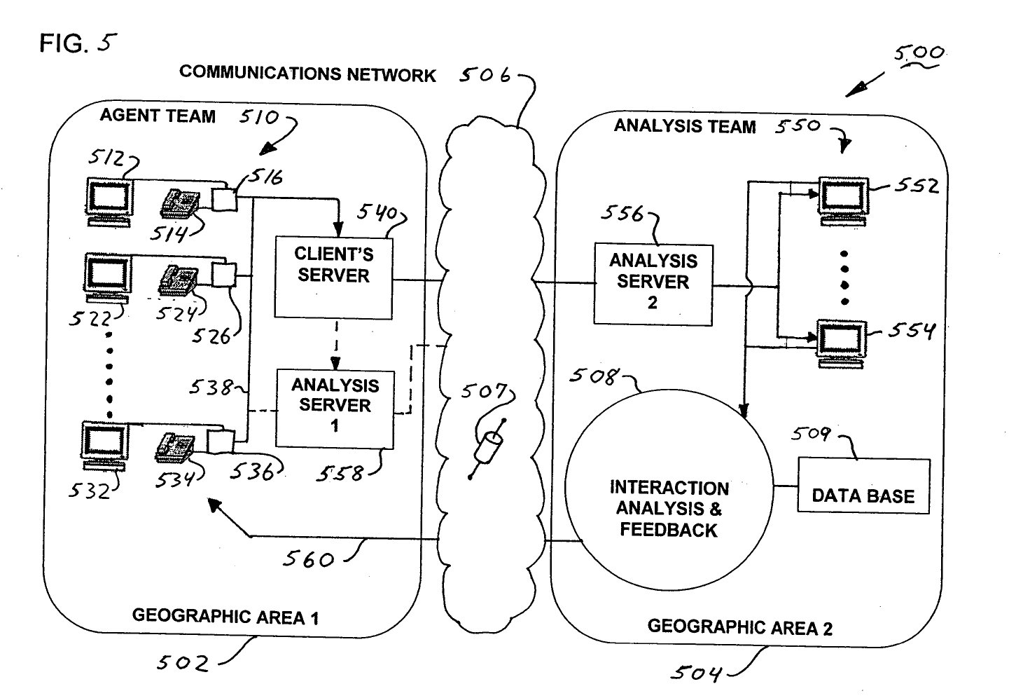

FIG. 5 illustrates one embodiment of contact center audio/video interaction monitoring generally shown at 500. With reference to FIG. 5, geographic area 502 and geographic area 504 are connected by communication network 506. Communications network 506 can be the Internet or a special purpose network configured to facilitate communications between the geographic areas in order to practice the invention. In one embodiment, communication network 506 can be a combination of general networks such as a business's intranet, the Internet, and special purpose networks configured to facilitate the practice of the invention. Communication network 506 can also include one or more satellites indicated by 507.

Within geographic area 502, one or more businesses engage in activity that requires audio/video interactions between agent(s) and customers of the business. For simplicity within this description, but without loss of generality to multiple businesses, the discussion within the remainder of this detailed description of embodiments of the invention will be limited to describing a single business. It will be recognized that the teachings herein are scalable to businesses of any size and to a plurality of businesses without limit on the number of businesses.

A business's customer contact center is indicated by agent team 510. Agent team 510 can contain a general number of agents as indicated in FIG. 5 within geographic area 502. The agent team need not all be located within the same geographic area. For simplicity, only two geographic areas have been presented herein, 502 and 504. Similarly, not all of the business's customers need to be located within geographic area 502. The customers can be located in any geographic area and need not be limited to the two geographic areas shown, 502 and 504. In one or more embodiments, other communications networks (not shown) provide communications between customers in other geographic areas and the agent team 510 as well as providing communications between agent teams located in different geographic areas or an agent team distributed between different geographic areas.

Workstations (devices) for three agents are shown in FIG. 5; however, a general number of workstations and agents is anticipated. A first agent's workstation consists of computer 512 and telephone 514. Video from a customer's device, such as device 204 (FIG. 2) can be displayed on the agent's device, such as computer 512. In one embodiment, the agent's device 224 (FIG. 2) is equivalent to the first agent's workstation consisting of computer 512 and telephone 514 (FIG. 5). Alternatively, telephone 514 can provide both audio and video, such as the VIZUFON® or Maia® devices described earlier. Audio and video from the interaction and corresponding customer account information, for example, are combined at 516 and stored on client's server 540. Similarly, a second agent's computer, indicated at 522 and telephone 524 are combined at 526 and routed to client's server 540. Client's intranet 538 can provide a data network within the business's customer contact center operation that facilitates data flow. A general maximum number of workstations is indicated by computer 532, and telephone 534, which are combined at 536 and coupled with client's server 540 through intranet 538. Without limitation to the teachings presented herein, intranet 538 can be a wired network, for example an Ethernet line, a wireless network, for example a network according to the 802.11(a) or 802.11(b) standard, or any other suitable communications network.

In one embodiment, a face-to-face audio/video interaction (FIG. 3) is incorporated in to the architecture of FIG. 5 by providing the output of device 304 (FIG. 3) to the analysis team 550 (FIG. 5); thereby making the face-to-face audio/video interaction available for analysis. Those of skill in the art will recognize that the output of device 304 (FIG. 3) can be supplied to analysis team 550 in a variety of ways. For example, the output of device 304 (FIG. 3) can be combined at 516 (FIG. 5) with the output of the computer 512 or the output of device 304 (FIG. 3) can replace the output of computer 512 and telephone 514. Different configurations of hardware will be assembled according to the needs of particular businesses. The present invention is not limited by the way that the output of device 304 (FIG. 3) is supplied to analysis team 550.

In one embodiment, all customer audio/video interactions, including pertinent data, are stored on the client's server 540 and/or on an analysis server 558. The analysis server one (1) at 558 can provide a backup function to the client's server 540 or replace the client's server 540 according to a particular hardware configuration employed with a particular business. In other embodiments, the agent/customer recording function can be provided by commercially available systems such as systems from NICE® or WITNESS® which would provide an output to the analysis server two (2) at 556 making these data available for analysis in geographic area 504 by an analysis team 550. Various protocols can be used to provide these data such as voice over Internet protocol (VoIP). Servers, such as 540 and 558, and any other device used to store the storable representations of the audio/video interactions can be any suitable device configured to store data; examples of which include, but are not limited to, magnetic and optical disk drives, solid state memory, tape drives, etc. Storable representations can be stored in analog or digital format. The present invention is not limited by the format used to store the audio/video interactions

Analysis team 550 is comprised of a team of individuals who are fluent in the language that the agents and customers converse in. Each analyst has a workstation, as indicated by workstation 552, up to a general number of analyst workstations 554, which receive data from analysis server 2 indicated at 556. An analyst's workstation is typically configured as a desktop computer, which has a data display device such as a monitor, flat panel display, etc. The workstation is typically configured with one or more data input devices such as a pointing device, a computer mouse, a touch pad, a keyboard, a voice activated interface including a microphone, local storage (which can also be used to store the storable representations of audio/video interactions), etc. The workstation need not be confined to a desktop computer configuration; a laptop computer, a handheld computer, and a wearable computer are all alternative configurations for the workstation. In one embodiment, there will be fewer analyst workstations than agent workstations since it is generally not required to analyze every audio/video interaction that the agent engages in. However, it is possible to employ a number of analysts sufficient to analyze every audio/video interaction that is made by every agent with every customer. In one embodiment, acceptable results are achieved with two to three analysts monitoring 50 to 70 agents interacting with customers in the airline reservation industry.

In one embodiment, the analysts review and evaluate agent/customer audio/video interactions to ensure that the agents have met quality of service criteria established for a particular business. In one embodiment, the evaluation process includes the areas of core skills, soft skills, selling skills, and specific know how. The analysts check core skills by analyzing the agent's method and competence in projecting an appropriate visual appearance, greeting and speaking with the customer, getting the order in the system, answering basic questions, and comprehension of a request made via email. Some analysis metrics used for report generation include the average interaction handle time and spelling and grammar used accurately during the audio/video interaction with the customer. Soft skills are checked by analyzing whether the agent's greetings are scripted, determining how “canned” the email responses are, determining whether the agent can handle an irate customer under pressure, and analyzing the agent's knowledge of when to engage the agent's supervisor to resolve a problem. Some analysis metrics used for report generation for soft skills include whether the customer's issue was resolved with the first interaction, this includes metrics related to specific know how (i.e., technical support/knowledge), and how many repeat interactions were required to resolve the customer's issue. Analyzing selling skills involves ranking the agent's ability to recommend additional products (cross-sell), sell more of the product under discussion by successfully understanding the tone and intonation of the customer during the audio/video interaction, and comprehension of the products and services. Some reporting metrics used in report generation for selling skills include measurements of the agent's up-sell and cross-sell performance. In some embodiments, reporting can include scoring compliance with regulations such as the Telephone Consumer Protection Act (TCPA) or other regulations.

For example, if the agent/customer audio/video interaction consisted of an inbound sales contact where a customer contacted the agent to place an order for a product, such as a camera, some of the criteria the analyst will be looking for are whether the agent has opened the interaction properly, acted courteously, attempted to up-sell (i.e., sell a higher end camera), cross-sell and add-on-sell (i.e., selling film and a camera accessory bag with the original camera order) the customer, and checking to determine if the agent was knowledgeable enough to meet the demands of the sale in order to accomplish the up-sell or cross-sell (e.g., could the agent explain the features and benefits and answer technical questions related to the product). Other criteria are employed as are appropriate for a particular industry. For example, in one embodiment, analysts will grade the audio/video interactions according to established quality monitoring criteria for a particular industry sector or a particular business. In one embodiment, an agent's performance is sampled at least once a day by the analysts generating analysis data and agent feedback. Analysis data is stored in data base 509 for later use and a portion thereof is tailored for the business and the business's agents at 508. Feedback is provided to the business and the agents at 560.

In one embodiment, wages earned by workers in geographic area 504 are lower than wages earned by workers in geographic area 502; thereby, creating geographic wage attenuation between the respective geographic areas. High frequency analysis of the agents' quality of service, provided to customer contacts, can be achieved while simultaneously increasing the business's profits. In one or more embodiments, a debit or a credit will be transferred in exchange for services provided by the analysts. An example of a debit is an invoice or a bill to show what is owed and an example of a credit is payment in the form of valuable consideration.

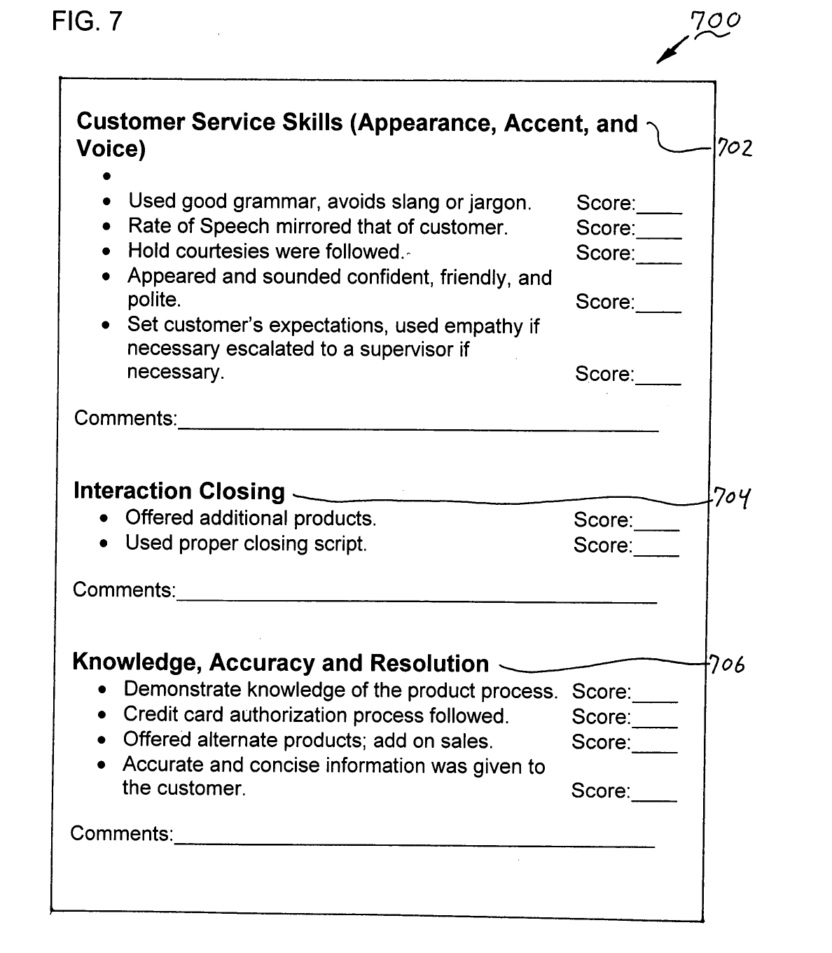

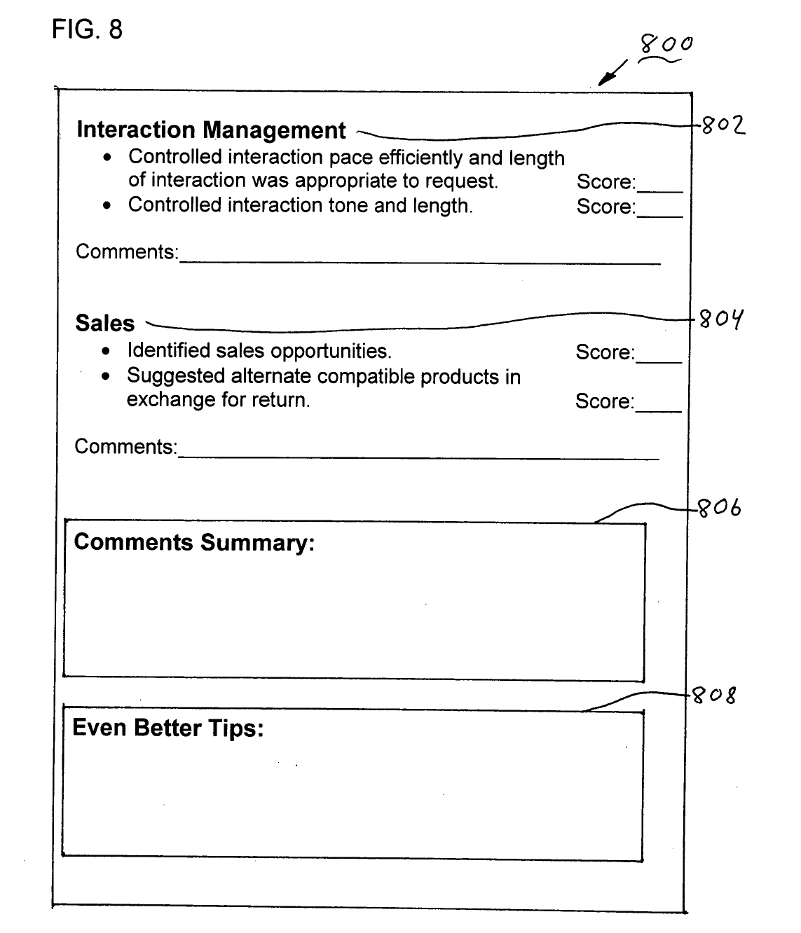

FIG. 6, FIG. 7, and FIG. 8 display an embodiment of a score sheet that can be used by an analyst to evaluate and score a transaction between an agent and a customer. With reference to FIG. 6, a score sheet is shown generally at 600 and continues onto FIG. 7 at 700 and onto FIG. 8 at 800. Score sheet 600 can be provided in many different ways, the embodiment depicted within the figures is but one of the many different formats that can be used to evaluate an agent/customer audio/video interaction. Score sheet 600/700/800 can be configured as a software application that is displayed on the analyst's workstation, such as workstation 552 in FIG. 5. Alternatively, score sheet 600/700/800 could be displayed on any data display configured to interact with the flow of data emanating from geographic area 502 (FIG. 5) which is accessible to analysts in geographic area 504 (FIG. 5).

An analyst evaluates an audio/video interaction between an agent and a customer by replaying or reviewing a stored representation of the audio/video interaction and then assigning a score to the components of the interaction based upon an evaluation of the interaction. In one embodiment, the evaluation proceeds with the analyst replaying a stored representation of an audio/video interaction. In the example shown in FIG. 6, FIG. 7 and FIG. 8, an evaluation consists of scoring an audio/video interaction between an agent and a customer. With reference to FIGS. 6, 7, and 8 collectively, the audio/video interaction can be broken down into the major categories of “Interaction Opening” 604, “Interaction Visual Aspects” 616, “Sales Presentation” 618, “Customer Service Skills” 702, “Interaction Closing” 704, “Knowledge, Accuracy and Resolution” 706, “Interaction Management” 802, “Sales” 804, “Comments Summary” 806, and “Even Better Tips” 808.

In the embodiment shown, “Interaction Opening” 604 has subcategories that are scored individually by the analyst. For example, the degree to which the agent used the proper greeting is assigned a score by the analysts at location 606. The score can be assigned using any suitable grading scale such as a numeric scale, an alphabetical scale or other scale created to rank the agent's performance. In one embodiment, a numeric scale can be used having a range of values from 1 to 10, where 1 indicates minimum compliance and 10 indicates maximum compliance. Other ranges can be used, such as 1 to 5; no limitation is implied by the ranges given in this description. Another subcategory, “Asked for Transaction ID,” is assigned a score after evaluation in location 608. The scoring for item 608 can be according to a two state yes/no score rather than a score that comprises more than two states. The other subcategories are scored and the analyst can enter comments pertinent to the category or subcategory in field 614.

In the context of the audio/video interaction, the customer and the agent can observe one another; therefore the visual appearance of the agent is of concern. In one embodiment, “Interaction Visual Aspects” 616 includes subcategories that assess whether the agent's clothing was appropriate and appeared neat, also evaluation of the agent's posture is performed. In one embodiment, the appearance of the agent's facial expressions is analyzed to see if the agent appeared empathetic to the customer.

In the context of an audio/video interaction it is possible for the agent to select information pertaining to a particular audio/video interaction and then display that information for the customer to view on the customer's device (such as device 204 in FIG. 2). “Sales Presentation” 618 can include such selections of information by the agent for the customer. The subcategories of 618 can include assessing whether the sales presentation was appropriate for the circumstances and whether the agent appeared overbearing and intimidating to the customer.

The other major categories 702, 704, 706, 802, and 804 are scored in a similar way, whereby the analyst assigns scores to the subcategories and comments as needed. A total score (not shown), representing the evaluation of the audio/video interaction, can be assigned either automatically by a scoring algorithm, as part of a computer based application, or by the analyst.

With reference to FIG. 8, fields for “Comments Summary” 806 and “Even Better Tips” 808 are provided. The analyst can provide a comment summary in field 806, if it is deemed necessary, after completing the evaluation. Additionally, the analyst can provide “Even Better Tips” in field 808. In one embodiment, “Even Better Tips” can include one or more elements of an audio/video interaction that the agent performed well and one or more elements of the audio/video interaction that the agent could perform even better, with a suggestion from the analyst explaining how the agent might achieve the increased performance. In another embodiment, the “Comments Summary” 806 can include one or more elements that the agent performed well and the “Even Better Tips” 808 can include one or more elements that the agent could perform even better.

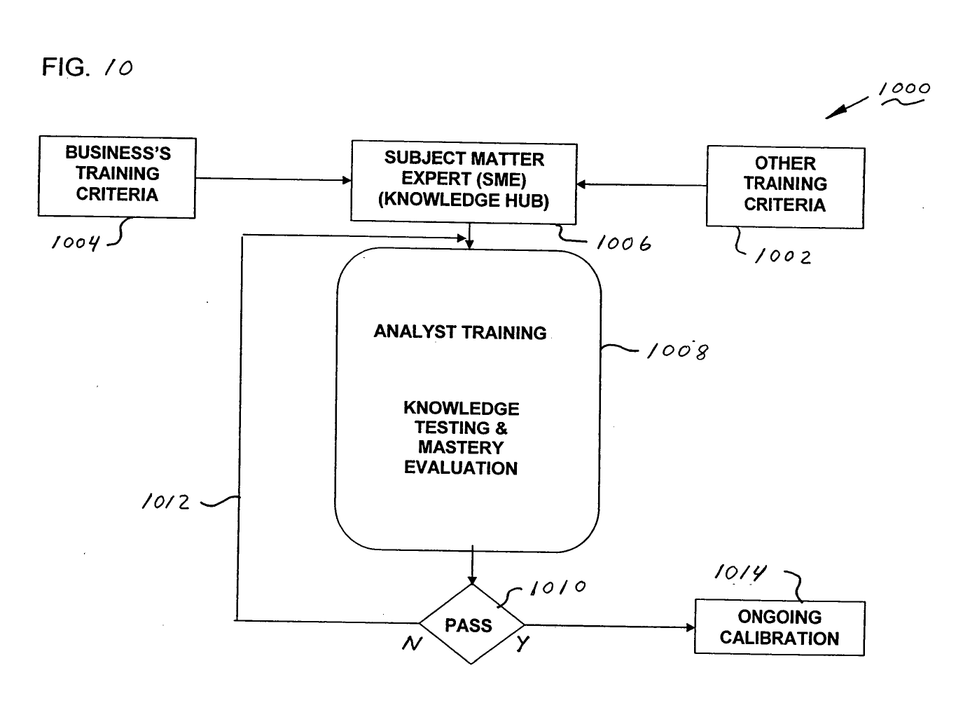

In one embodiment, the score sheet can serve as a training aid to the analyst by apprising the analyst of new information pertinent to the business's activity or reminding the analyst of information that is of particular importance. For example, in FIG. 6, field 602 can be implemented as a scrolling update bar in a window on a data display for the benefit of the analyst; thereby, displaying information as shown in the figure. Training the analysts will be described more completely below in conjunction with FIG. 10.

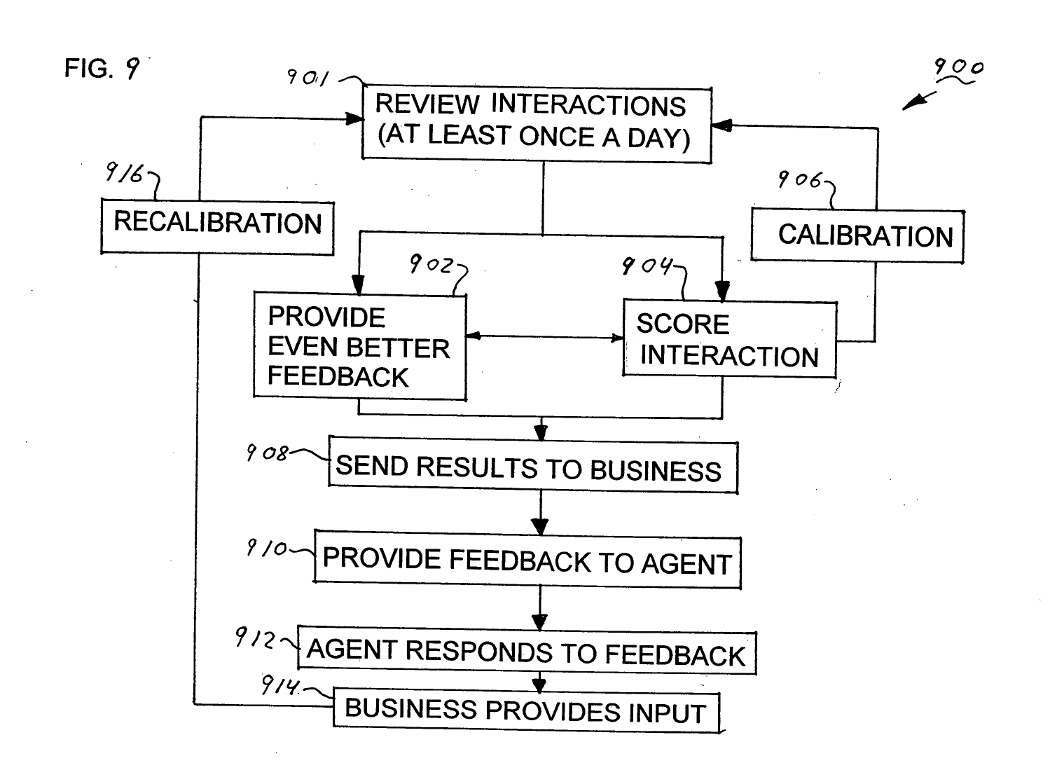

FIG. 9 illustrates a flow diagram for audio/video interaction analysis and feedback according to one embodiment, generally shown at 900. With reference to FIG. 9, analysts review and evaluate audio/video interactions between agents and customers at 901. Such evaluations can be performed according to the description associated with FIG. 6, FIG. 7, and FIG. 8. Initially, a calibration loop 902-904-906 provides uniformity in scoring an agent's performance by submitting the same agent's data to the entire team of analysts multiple times and reviewing the scored results between the analysts until the variation between analysts' scores of the same agent's data is within acceptable limits (internal calibration). The same calibration process follows between the team of analysts and the agent's specific team supervisor and/or manager. The agent, the agent's team supervisor or the agent's manager can be referred to as the client, in such a case, calibrating the analysts to one or more of these entities associated with the particular business can be referred to as a “client calibration.” Acceptable calibration limits will be determined by the requirements of particular businesses; however, in one embodiment, a deviation of five percent (5%) between individual analyst's agent-scores (internal calibration) is one example of an acceptable level of uniformity and a deviation of five percent (5%) during a client calibration is one example of an acceptable level of uniformity.

Calibration of the audio/video interaction evaluation process can also be performed by using Anonymous Transaction Simulations (ATS). During an ATS calibration, a common audio/video interaction is delivered to all or a specific group of analysts to score. The scoring can also include the analysts adding their particular even better tips. During the ATS calibration, the analysts are unaware that the audio/video interaction is a common replicate. The common audio/video interaction need not be an actual audio/video interaction, but it can be an audio/video interaction designed to test a particular category or subcategory of a audio/video interaction. The agent's manager, supervisor or the analyst's supervisor or subject matter expert (described in conjunction with FIG. 10) can use the ATS to test specific training updates, issues or unique customer audio/video interaction scenarios.

Further calibration can be provided by the analyst's supervisor or subject matter expert in the form of a random quality audit. In one embodiment, during a random quality audit, the analyst's evaluation(s) of one or more agent/customer audio/video interactions are evaluated by the analyst's supervisor, subject matter expert, or equivalent manager.

As previously described in conjunction with FIG. 5, agent teams (sometimes referred to as customer contact centers) can be located in different geographic areas or at different locations within a single geographic area. Therefore, a business can have a plurality of customer contact centers across which the previously described calibration processes can be performed. One or more of these customer contact centers can be located internal to the business and one or more of these customer contact centers can be located external to the business. The calibration processes described herein are equally applicable to a mixture of internal and external customer contact centers. An example of an internal customer contact center is, but is not limited to, a center operated under the control of the business. An example of an external customer contact center is, but is not limited to, a customer contact center that is operated under limited control or influence by the business, such as by contractors or a contractor provided service via an external customer contact center.

The interaction score 904 and even better feedback 902 are sent to the business at 908. Feedback is provided to the respective agents at 910. Agents can respond to the feedback at 912 and the business provides input at 914. Depending on the agent's response and the input from the business, recalibration of the analysts may be required at 916. The process described in FIG. 9 is flexible and accommodates agents' responses and the contact center management's response by customizing scoring as needed. In one embodiment, the even better feedback 902 includes informing an agent of an agent performance element that was well performed, and informing the agent of a performance element that could be performed even better than the way the agent presently performs the element. Additionally, the even better feedback 902 can include training tips, provided as appropriate to contact center management or the agent based on analyzing the agent's audio/video interaction with customers.

In various embodiments, the invention can be applied to suit the needs of any business. Specific knowledge about the procedures, processes, products, and/or services of any business can be assimilated by the analysts during training; thereby, allowing the analysts to become an extension of the business's customer contact center. FIG. 10 displays a training flow chart at 1000, according to one embodiment of the invention. With reference to FIG. 10, “Business's Training Criteria” 1004 includes information relevant to the business that needs to be considered in the context of evaluating an agent/customer audio/video interaction. Information 1004 flows as needed to a subject matter expert 1006. The subject matter expert 1006 ensures that the pertinent information, 1004, is disseminated to and assimilated by the analysts as needed. As indicated previously in conjunction with FIG. 6 at 602, the subject matter expert can provide training updates to the analysts. The subject matter expert effectively functions as a knowledge hub, maintaining a knowledge base and communicating this knowledge, comprising product, service, process, updates, etc. to the analysts.

In one or more embodiments, analysts receive training in block 1008; the training is based on the requirements that are compiled by the subject matter expert in 1006. In one embodiment, an analyst's training includes reading an update when the analyst logs onto a workstation, such as 552 in FIG. 5, before the analyst can proceed to evaluate agent/customer audio/video interactions. The analyst can be required to check a confirmation box before being allowed to proceed to evaluations.

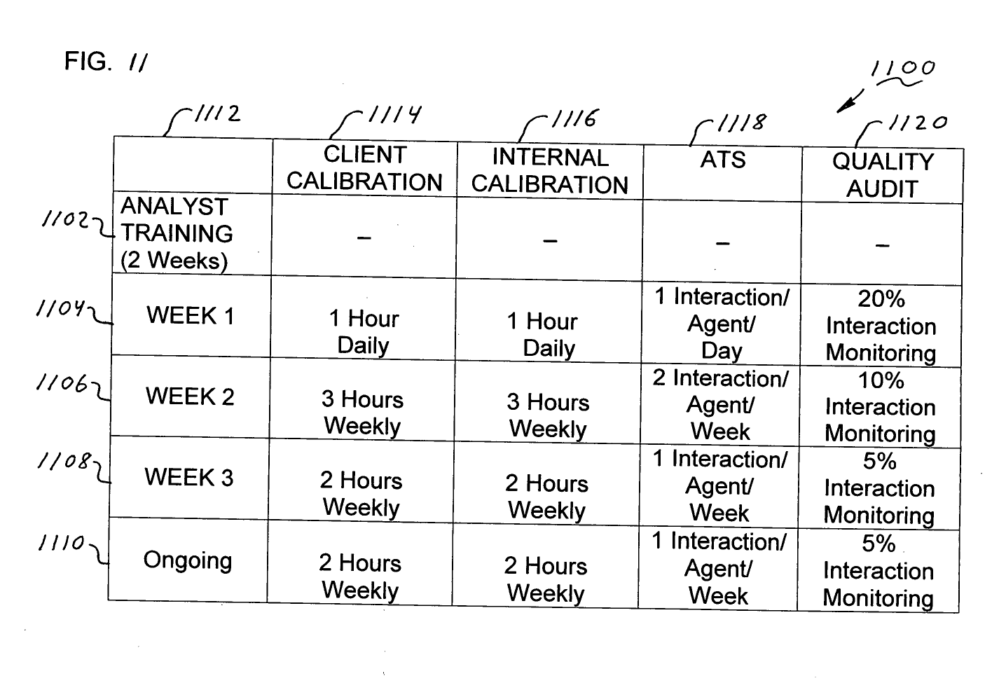

The analyst's knowledge can be improved by the subject matter expert, such improvement directly enhances client calibration results; thereby minimizing discrepancies between an analyst's score and the score that an agent's manager would give for the same audio/video interaction. Internal calibration is also improved by increasing the analyst's knowledge of information 1004 and other training criteria 1002 as is appropriate. The subject matter expert can improve the analyst's knowledge by creating knowledge testing programs. In one embodiment, test questions are compiled by the subject matter expert and passing criteria are set at 1010. If an analyst meets the passing criteria by achieving a passing grade on the knowledge test then that analyst can proceed to perform evaluations of audio/video interactions. Those audio/video interactions will continue to be the subject of ongoing calibration as indicated at 1014. Ongoing calibration will be described more fully in conjunction with FIG. 11. If the analyst does not meet the passing criteria at 1010 then further training is indicated by path 1012.

At times it may be desirable to communicate urgent updates to the analysts in the form of a verbal communication from the subject matter expert, some other person or an automated system. In such a case, a hold can be administered, which would prevent the analysts from evaluating the audio/video interaction until the analysts are addressed and the hold is removed.

In some embodiments, the training described herein with respect to the analysts can be directed to the business's agents. This training can be administered in the form of training updates, quizzes, or online exercises. Agent training can be adapted to the specific needs of a particular business.

In other embodiments, other training criteria 1002, such as knowledge amassed from services provided to a first business can be directed toward improving the performance of a second business. Other training criteria 1002 can include data accumulated from the evaluations of the agent/customer audio/video interactions (the evaluations can be performed at various frequencies as described herein) as well as the training criteria and knowledge assembled by the subject matter expert or other personnel or automated system.

Various types of calibration were described in conjunction with FIG. 9, these types of calibration can be combined and applied to both minimize the length of time needed to train and deploy a team of analysts to commence evaluation of a business's agent/customer audio/video interactions, and to minimize the length of time required for a business's agent team to gain operational competency with respect to the subject matter of the business.

Seasonal or limited duration agents, such as non-full time employees or contractors, present training problems for many businesses since these agents are typically hired for a short period of time and the agents must be trained in an even shorter period of time. For a business to enjoy a productive period of working time from these agents, the agents must be trained in a time period that is shorter than the duration of the season or time period for which they were hired to work in. Therefore, it is desirable to shorten the training period of the agents as much as possible.

In one embodiment, of the invention, a calibration process for a business's agents is described with the aid of FIG. 11. In this embodiment, the agents can be short duration or seasonal employees or contractors. No limitation is implied by the type of work relationship that exists between the person (agent) and the business, e.g., agent, employee, or contractor. With reference to FIG. 11, a table 1100 displays a calibration timeline, where time proceeds down the rows of the table 1100, e.g., 1102, 1104, 1106, 1108, and 1110. The types of calibration are displayed as columns in table 1100, e.g., 1114, 1116, 1118, and 1120.

In this embodiment, the analysts are trained for two (2) weeks as described in conjunction with FIG. 10; thereby, allowing the analysts to assimilate the pertinent information from sources 1004 and/or 1002 (FIG. 10). This two week training period is indicated at row 1102, column 1112 in FIG. 11. Week one consists of a nesting period, row 1104, where one hour of client calibration 1114 and one hour of internal calibration 1116 is undertaken daily to ensure that the analysts produce evaluations that are consistent with evaluations that the client would produce and that the analysts' evaluations are internally consistent. Also within the first week, Anonymous Transaction Simulations (ATS) are administered at the rate of one (1) audio/video interaction per agent per day at 1118. The analysts' evaluations are audited within column 1120 for quality at the rate of twenty (20) percent of the total evaluations performed to ensure rapid convergence of the analysts' evaluations and to spot problems that might need to be addressed early in the calibration process.

During week two (2), indicated by row 1106, the client calibration 1114 is reduced to three (3) hours a week and the internal calibration 1116 is reduced to three (3) hours a week. During this second week, the ATS rate 1118 can be decreased to two (2) audio/video interactions per agent per week and the quality audit 1120 can be decreased to ten (10) percent of the total audio/video interactions evaluated.

During week three (3), indicated by row 1108, the client calibration 1114 is reduced to two (2) hours a week and the internal calibration 1116 is reduced to two (2) hours a week. During this second week, the ATS rate 1118 can be decreased to one (1) audio/video interaction per agent per week and the quality audit 1120 can be decreased to five (5) percent of the total audio/video interactions evaluated. Presumably, the seasonal employees of the business (agents) are learning the material required for their seasonal job with the passage of time and the frequency of the types of calibration administered can be reduced as the passage of the successive weeks indicates.

In the fourth and subsequent weeks, indicated by row 1110, ongoing calibration will consist of two hours of client calibration 1114 a week, two (2) hours of internal calibration 1116 a week; one (1) ATS transaction per agent per week 1118; and a five (5) percent quality audit 1120 of the total audio/video interactions evaluated.

In the previous description, durations of the various types of calibration were given as examples; no limitation is implied by these durations such as numbers of weeks, hours, percentages, etc. These quantities are illustrative of one embodiment. Other time periods and frequencies are possible and appropriate to meet the particular needs of specific businesses and business objectives.

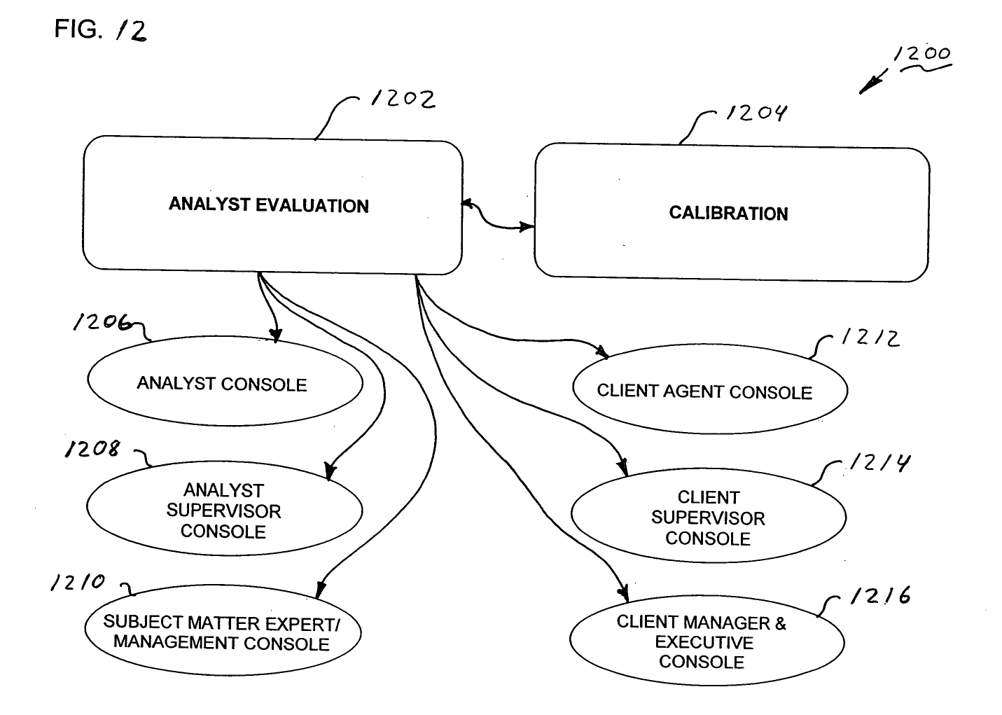

In one or more embodiments of the invention, communication between agents, analysts, support personnel (subject matter experts), etc., and the respective managers is accomplished with the aid of the networks described in conjunction with the previous figures. Components of an integrated software application that incorporates the previously described functionality is illustrated in FIG. 12, according to one embodiment of the invention.

FIG. 12 is one embodiment of an Internet based agent level evaluation feedback tool, shown generally at 1200. With reference to FIG. 12, analyst evaluations are indicated within block 1202. The analysts receive audio/video interactions and the appropriate evaluation criteria based on a particular business and the pertinent product/service knowledge. The evaluations of the agent/customer audio/video interactions involve monitoring the audio/video interactions at an agent level, scoring evaluations, reporting on trends and opportunity areas for the business, providing even better tips, compliance monitoring, and other feedback as needed by the particular business, as well as making this information available to the business.

As previously described, these evaluations 1202 are the subject of different types of calibration; internal calibration, client calibration, Anonymous Transaction Simulations (ATS), and quality audits, all indicated generally at 1204. These calibrations raise the performance level of the analysts and the business's agents as previously described.

In one embodiment, an Analyst's Console 1206 provides the analyst with project updates, is used during calibration, displays quality and productivity scores, can be used for knowledge testing and other communications from, for example, the subject matter expert or others as previously described.

In one embodiment, the Supervisor's Console 1208 provides the analysts' supervisor with data on one or more of the particular campaigns that can be in progress for one or more businesses, which are being supported by the analysts as described herein. Supervisor's Console 1208 can provide information to the supervisor, such as but not limited to; real-time campaign results, project updates, agent team and/or agent level reporting, subject matter expert (SME) feedback, audio/video interaction evaluations, etc.

In one embodiment, a SME/Management Console 1210 can be used to provide a reporting suite for analysis, track training updates, provide training suggestions, maintain a knowledge base, etc.

In one embodiment, information is divided between the analyst side, as described above, and the client (business) side. The client side can include a Client Agent Console 1212, which can provide feedback to the agents on items such as the agent's customer audio/video interactions that were evaluated and the associated scores, comments, even better feedback tips, etc. Client Agent Console 1212 can also include agent improvement results or lack of improvement, previous audio/video interactions identified for agent self-awareness, etc. Client Agent Console 1212 can also provide the agent with training updates, quizzes, and on-line exercises as needed to suit a particular business's need.

In one embodiment, a Client Supervisor Console 1214 can provide data such as, agent level scores, top defects in agent performance, stack ranking of agents' performance, agent team reports, trend analysis, individual and agent team based improvements, training suggestions, and improvement margins.

In one embodiment, a Client Manager & Executive Console 1216 can include agent and agent team trends, stack ranking, top defects, training and process improvement suggestions, agent team performance improvement margins, etc.

In general, the consoles described in relation to FIG. 12 can be tailored to the needs of any business that requires customer audio/video interactions. The description of information available on the various consoles of FIG. 12 is illustrative of one or more embodiments of the invention and is not to be taken in a limiting sense. Various other compilations of information and functionality will be apparent to those of skill in the art from the teachings presented herein.

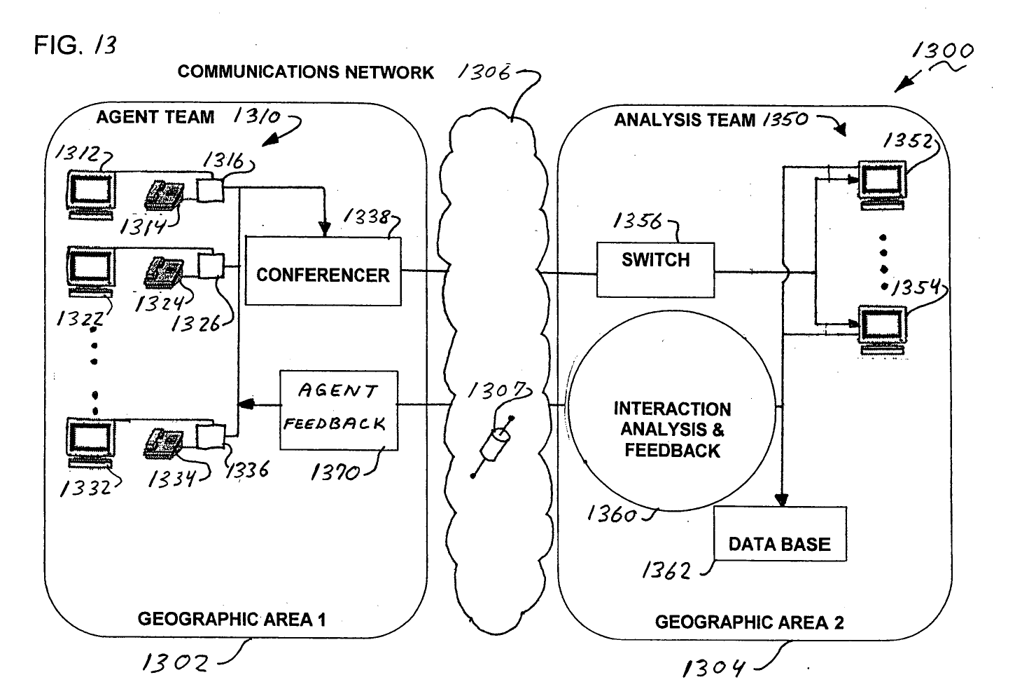

FIG. 13 illustrates real-time contact center monitoring according to one embodiment of the invention, generally shown at 1300. A business's customer contact center is indicated by agent team 1310 within geographic area 1302. Not all of the business's customers need to be located within geographic area 1302. The customers can be located in any geographic area and need not be limited to the two geographic areas shown, 1302 and 1304. Agent team 1310 can contain a general number of agents as indicated in FIG. 13 within geographic area 1302. The agent team need not all be located within the same geographic area. For simplicity, only two geographic areas have been presented herein, 1302 and 1304. Other communications networks (not shown) provide communications between customers in other geographic areas and the agent team 1310 as well as providing communications between agent teams located in different geographic areas or an agent team distributed between different geographic areas.

A first agent's workstation consists of computer 1312 and telephone 1314. Video from a customer's device, such as device 204 (FIG. 2) can be displayed on the agent's device, such as computer 1312. In one embodiment, the agent's device 224 (FIG. 2) is equivalent to the first agent's workstation consisting of computer 1312 and telephone 1314 (FIG. 13). Alternatively, telephone 1314 can provide both audio and video, such as the VIZUFON® or Maia® devices described earlier. Audio and video from the audio/video interaction and corresponding customer account information, for example, are combined at 1316 and are available to conference via 1338 to the analysis team 1350 in the second geographic area 1304. Similarly, a second agent's computer indicated at 1322 and telephone 1324 are combined at 1326 and routed to interaction conferencer 1338. A general maximum number of workstations is indicated by computer 1332 and telephone 1334. Computer 1332 and telephone 1334 are combined at 1336 and routed to 1338.

In one embodiment, a face-to-face audio/video interaction (FIG. 3) is incorporated in to the architecture of FIG. 13 by providing the output of device 304 (FIG. 3) to the analysis team 1350 (FIG. 13); thereby making the face-to-face audio/video interaction available for analysis. Those of skill in the art will recognize that the output of device 304 (FIG. 3) can be supplied to analysis team 1350 in a variety of ways. For example, the output of device 304 (FIG. 3) can be combined at 1316 (FIG. 13) with the output of the computer 1312 or the output of device 304 (FIG. 3) can replace the output of computer 1312 and telephone 1314. Different configurations will be assembled according to the needs of particular businesses. The present invention is not limited by the way that the output of device 304 (FIG. 3) is supplied to analysis team 1350.

Communications network 1306 couples geographic area 1302 with geographic area 1304 allowing information to flow between the respective areas. Communications network 1306 can include one or more satellites as indicated by 1307. Communications network 1306 facilitates the flow of agent/customer audio/video interactions from interaction conferencer 1338 in geographic area 1302 to switch 1356 in geographic area 1304. Interaction conferencer 1338 can include a device such as an automatic call distributor (ACD).

Analysis team 1350 is comprised of analysts and analyst workstations 1352 up to a general number indicated by 1354. Agent/customer audio/video interactions are distributed to analysts through switch 1356 providing real-time monitoring by the analysts. Near real-time audio/video interaction analysis 1360 provides the agent with nearly immediate feedback 1370 on his or her performance during the customer contact. Such feedback to an agent enhances learning and decreases learning curve time, generally apparent with new agents. Ongoing analyses of agent/customer audio/video interactions are compiled in the data base 1362. In one embodiment, the feedback supplied to an agent can be displayed on device 224 (FIG. 2).

In one embodiment, wages earned by workers in geographic area 1304 are lower than wages earned by workers in geographic area 1302; thereby, creating geographic wage attenuation between the respective geographic areas. High frequency analysis of the agents' quality of service, provided to customer contacts, can be achieved while simultaneously increasing the business's profits. In one or more embodiments, a debit or a credit will be transferred in exchange for analysis services provided by the analysts. An example of a debit is an invoice or a bill to show what is owed and an example of a credit is payment in the form of valuable consideration.

Within the figures presented in this detailed description of embodiments, separate paths have been used to depict the flow of customer audio/video interaction data and feedback from the analysis of these data for simplicity, no limitation is implied by this depiction. It will be realized by those of skill in the art that communication systems can support bidirectional communication over a single transmission line. Such bidirectional systems could be represented by a single line or path between points in a communications link, no limitation is implied thereby.

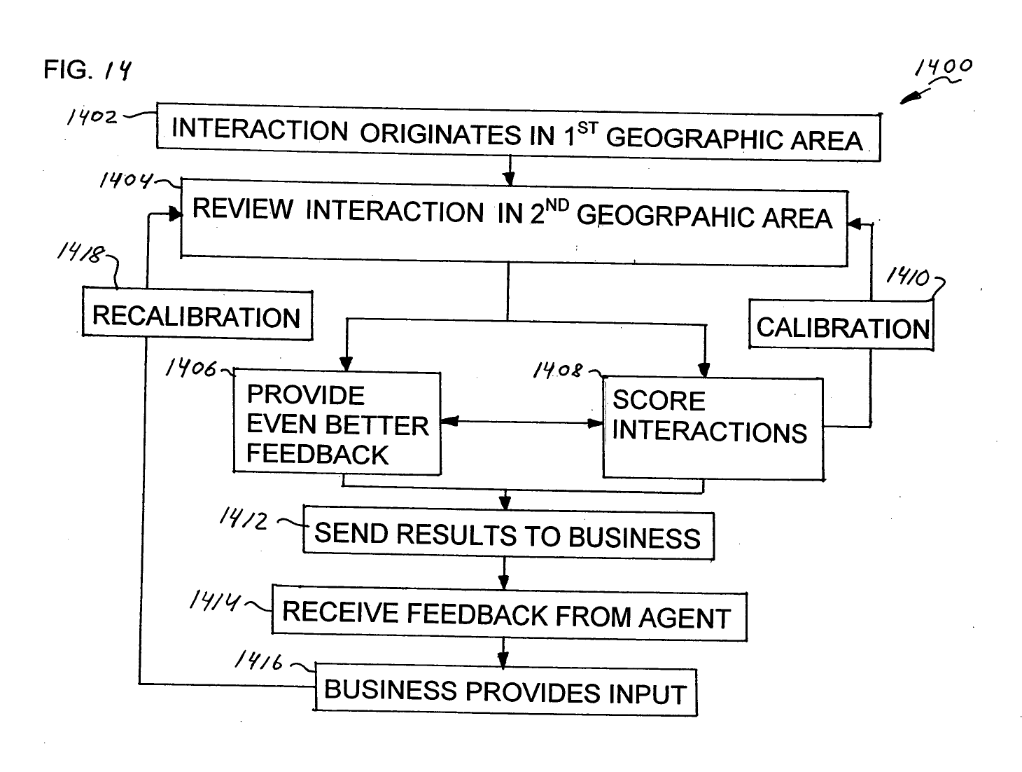

In one embodiment, FIG. 14 illustrates a flow diagram for audio/video interaction analysis corresponding to FIG. 13 and generally depicts the process at 1400. With reference to FIG. 14, in one embodiment, audio/video interactions originate in the first geographic area 1402; customers and agents can be located in geographic areas other than 1402, as described in conjunction with the previous figures. Analysts in the second geographic area 1404 evaluate the audio/video interactions in near real-time to provide concurrent feedback to the agent. Calibration of the evaluation process is indicated by a calibration loop 1406-1408-1410 to provide uniformity in scoring an agent's performance by conferencing the same agent's audio/video interaction to the team of analysts and reviewing the analysts' responses with the analysts (facilitated by an analyst supervisor or other facilitator) until the variation between the analysts' responses to the same agent's data is within acceptable limits. Acceptable calibration limits will be determined by the requirements of particular businesses; however, in one embodiment, a deviation of three percent (3%) between individual analyst's agent-scores is one example of an acceptable level of quality.

Even better feedback at 1406, along with the audio/video interaction, scored at 1408, is provided to the agent in near real-time. Information from the analysts can be displayed directly on an agent's computer monitor such as computer 1312, 1322 or 1332 (FIG. 13) or device 224 (FIG. 2). In one embodiment, near real-time results are sent to the business's contact center management at 1412 as well as other levels of the business organization as are appropriate. Feedback is received from the agent at 1414, input on the analysts' reports and even better performance suggestions are analyzed by the business and input is fed back to a recalibration process 1418 that ensures that the scoring 1408 and 1406 are in accordance with the goals of the particular business. Following this process, embodiments can be adapted and scaled to the needs and size of particular businesses.

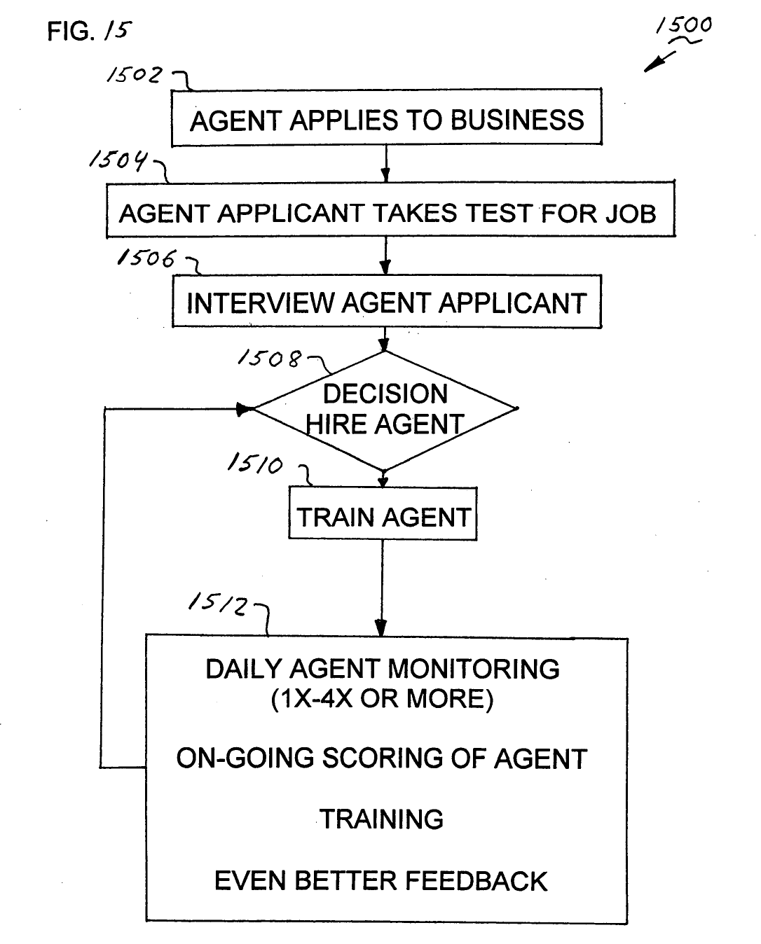

In one or more embodiments, FIG. 15 illustrates a flow diagram employing a data base, generally shown at 1500. With reference to FIG. 15, the data base representing the accumulation of data on agents' performance during contact center audio/video interactions is collected on a substantially continuing basis and is used by a business to guide the business's future decisions with respect to hiring an agent for a particular job. At 1502, an agent applies for a job with a particular business. The agent applicant takes a test at 1504 to determine the prospective agent's suitability for the particular job. The agent is interviewed for the particular job at 1506 and a decision to hire the agent is made at 1508 based in part on the agent's application, interview, and the data base. The data base can be used to filter the application and interview elements based on agent characteristics that have been found to correlate with successful agent performance. For example, in one embodiment, it has been discovered that an agent's ability and propensity to up-sell during a sales contact is increased if the agent personally participates in and uses the product that the customer is asking about. Therefore, in certain fields, the business will prefer to hire applicant's who have personal experience using products that the business is selling.

Following hiring, training occurs at 1510. Training times are also recorded in the data base and are also used to guide future hiring decisions. Process 1512 can include an accelerated 4X monitoring phase that in one or more embodiments is useful to train agents in certain industries. For example, when a new seasonal line of clothing is introduced, it is advantageous to enhance the feedback that agents receive by monitoring the agents' performance six times a day (6X). In another embodiment, when a new promotional program is introduced, such as a new cruise line vacation package, 4× training provides for a shorter learning curve for the agent which results in revenue improvement for the business.

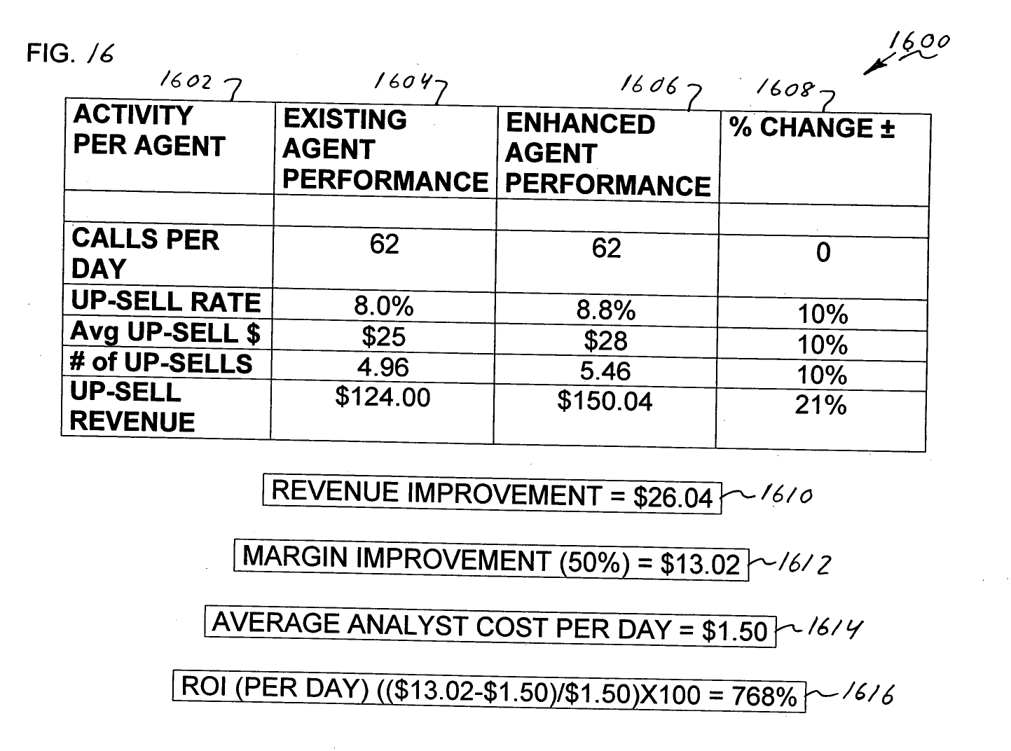

FIG. 16 illustrates an example of increased profitability according to one embodiment of the invention. With reference to FIG. 16, a single agent's contribution to increasing the profitability of a business is shown generally at 1600. Single agent activity is shown in column 1602. Existing agent performance without the improvements taught herein is shown in column 1604. The enhanced agent performance provided by the teachings according to one embodiment of the invention provides an increase in the agent's up-sell rate from 8.0% (1604) to 8.8% (1606). This up-sell rate increase is applied to 4.96 up-sell audio/video interactions a day (1604) increasing the number of up-sell audio/video interactions to 5.46 (1606). Up-sell revenue is increased from $124.00 (1604) to $150.04 (1606). Subtracting these two numbers provides a revenue improvement of $26.04 as indicated at 1610. A profit margin of 50% on the revenue improvement of $26.04 produces an increased profit of $13.02 as indicated at 1612. The average daily cost to the business for the analyst is $1.50 at 1614 with a geographic wage attenuation of 0.2, resulting in a daily return on investment (ROI) of 768% as indicated at 1616.

It will be appreciated that the methods described in conjunction with the figures may be embodied in machine-executable instructions, e.g. software. Alternatively, some of the methods can involve the participation of an operator with a general-purpose processor that is programmed with the instruction to perform the operation described. The instructions can be used to cause a general-purpose or special-purpose processor that is programmed with the instructions to perform the operations described. Alternatively, the operations might be performed by specific hardware components that contain hardwired logic for performing the operations, or by any combination of programmed computer components and custom hardware components. The methods may be provided as a computer program product that may include a machine-readable medium having stored thereon instructions which may be used to program a computer (or other electronic devices) to perform the methods. For the purposes of this specification, the terms “machine-readable medium” shall be taken to include any medium that is capable of storing or encoding a sequence of instructions for execution by the machine and that cause the machine to perform any one of the methodologies of the present invention. The term “machine-readable medium” shall, accordingly, be taken to include, but not be limited to, solid-state memories, optical and magnetic disks, and carrier wave signals. Furthermore, it is common in the art to speak of software, in one form or another (e.g., program, procedure, process, application, module, logic . . . ), as taking an action or causing a result. Such expressions are merely a shorthand way of saying that execution of the software by a computer causes the processor of the computer to perform an action or produce a result.

As used in this description, “one embodiment,” “one or more embodiments,” “an embodiment” or similar phrases means that feature(s) being described are included in at least one embodiment of the invention. References to “one embodiment” or any reference to an embodiment in this description do not necessarily refer to the same embodiment; however, neither are such embodiments mutually exclusive. Nor does “one embodiment” imply that there is but a single embodiment of the invention. For example, a feature, structure, act, etc. described in “one embodiment” may also be included in other embodiments. Thus, the invention may include a variety of combinations and/or integrations of the embodiments described herein.

While the invention has been described in terms of several embodiments, those of skill in the art will recognize that the invention is not limited to the embodiments described, but can be practiced with modification and alteration within the spirit and scope of the appended claims. The description is thus to be regarded as illustrative instead of limiting.

1. A method comprising:
receiving a storable representation of an audio/video interaction between an agent of a business and a customer;
analyzing the storable representation to determine service quality provided to the customer by the agent; and
generating analysis data associated with the analyzing.

2. The method of claim 1, wherein the business is located in a first geographic area and the analyzing occurs in a second geographic area and the second geographic area is subject to a geographic wage attenuator.

3. The method of claim 1, wherein the agent and the customer are face-to-face during the audio/video interaction.

4. The method of claim 1, wherein the agent and the customer are not face-to-face during the audio/video interaction.

5. The method of claim 1, wherein a device is used to obtain the storable representation of the audio/video interaction.

6. The method of claim 5, wherein the device is selected from the group consisting of a video-telephone, a workstation, an audio/video monitoring system, a lap-top computer, a personal data assistant, a tablet computer and a wearable computer.

7. The method of claim 1, further comprising:
transmitting the storable representation to a second geographic area.

8. The method of claim 1, wherein the analyzing occurs at a frequency that requires at least one of the agent's audio/video interactions per day to be analyzed for service quality.

9. The method of claim 1, wherein the analyzing occurs at a frequency selected from the group consisting of at least once per day, more than once per day and a frequency sufficient to provide a statistically relevant sample of the agent's audio/video interactions.

10. The method of claim 1, further comprising:
informing the agent of at least one agent performance element that could be performed even better.

11. The method of claim 10, further comprising:
notifying the agent of at least one agent performance element that was well performed.

12. The method of claim 1, further comprising:
providing a training tip for the agent based on the analyzing.

13. The method of claim 1, further comprising:
transferring a debit or a credit in exchange for analyzing the audio/video interaction.

14. An apparatus comprising:
a storage device configured to receive and store a storable representation of an audio/video interaction between an agent of a business and a customer, the storable representation is capable of being analyzed for service quality by an analyst; and
a report generator configured to generate analysis data, the analysis data representing the quality of service rendered by the agent to the customer.

15. The apparatus of claim 14, wherein the business is located in a first geographic area and the storable representation is analyzed for service quality in a second geographic area and the second geographic area is subject to a geographic wage attenuator.

16. The apparatus of claim 14, wherein the agent and the customer are face-to-face during the audio/video interaction.

17. The apparatus of claim 14, wherein the agent and the customer are not face-to-face during the audio/video interaction.

18. The apparatus of claim 14, wherein a device is used to obtain the storable representation of the audio/video interaction.

19. The apparatus of claim 18, wherein the device is selected from the group consisting of a video-telephone, a workstation, an audio/video monitoring system, a lap-top computer, a personal data assistant, a tablet computer and a wearable computer.

20. The apparatus of claim 15, further comprising a communication link to facilitate communications between the first geographic area and the second geographic area.

21. The apparatus of claim 20, wherein the communication link further comprises a satellite.

22. The apparatus of claim 14, wherein an analysis frequency applied to the agent's audio/video interactions is selected from the group consisting of at least once per day, more than once per day and a frequency sufficient to provide a statistically relevant sample of the agent's audio/video interactions.

23. The apparatus of claim 14, wherein at least one of the agent's audio/video interactions per day is analyzed for service quality.

24. The apparatus of claim 14, wherein the analysis data further comprises:
an agent performance element that could be performed even better.

25. The apparatus of claim 24, wherein the analysis data further comprises:
an agent performance element that was well performed.

26. The apparatus of claim 14, wherein the analysis data further comprises:
a training tip for the agent based on analyzing the agent's audio/video interactions.

27. The apparatus of claim 22, further comprising:
a data base comprising a plurality of analysis data collected from the agent.

28. The apparatus of claim 23, further comprising:
a data base comprising a plurality of analysis data collected from the agent.

29. The apparatus of claim 15, wherein the first geographic area is the United States of America and the second geographic area is selected from the group consisting of Botswana, Fiji, India, Kenya, Liberia, Nigeria, South Africa, Swaziland, Tanzania and the Philippines.

30. The apparatus of claim 15, wherein the first geographic area is the United States of America and the second geographic area is external to the United States of America.

31. The apparatus of claim 15, wherein the first geographic area is the United States of America and the second geographic area is selected from the group consisting of Argentina, Dominican Republic, Ecuador, El Salvador, Equatorial Guinea, Republic of the Congo, Mexico, Nicaragua, Panama and Uruguay.

32. The apparatus of claim 15, wherein the first geographic area is France and the second geographic area is selected from the group consisting of Algeria, Rwanda, Senegal and Haiti.

33. The apparatus of claim 14, wherein a debit or a credit is transferred in exchange for analysis of the audio/video interaction.

34. A method comprising:
monitoring an audio/video interaction between an agent of a business and a customer;
analyzing the audio video interaction to determine the service quality provided to the customer by the agent; and
generating analysis data associated with the analyzing.

35. The method of claim 34, wherein the business is located in a first geographic area the analyzing occurs in a second geographic area and the second geographic area is subject to a geographic wage attenuator.

36. The method of claim 34, wherein the analyzing occurs at a frequency that requires at least one of the agent's interactions per day to be analyzed for service quality.

37. The method of claim 34, wherein the audio/video interaction further comprises data associated with the audio/video interaction.

38. The method of claim 34, further comprising:
informing the agent of at least one agent performance element that could be performed even better.

39. The method of claim 38, further comprising:
notifying the agent of at least one agent performance element that was well performed.

40. The method of claim 34, further comprising:
providing a training tip for the agent based on the analyzing.

41. The method of claim 34, further comprising:
transferring a debit or a credit in exchange for analysis of the audio/video interaction.

42. An apparatus comprising:
a receiver configured to receive an audio/video interaction between an agent of a business and a customer, the audio/video interaction is capable of being analyzed for service quality by an analyst; and
a report generator configured to generate analysis data, the analysis data indicating the quality of service rendered by the agent to the customer after the agent's performance is analyzed by at least one analyst.

43. The apparatus of claim 42, wherein the business is located in a first geographic area and the audio/video interaction is capable of being analyzed for service quality in a second geographic area and the second geographic area is subject to a geographic wage attenuator.

44. The apparatus of claim 42, wherein the agent and the customer are face-to-face during the audio/video interaction.

45. The apparatus of claim 42, wherein the agent and the customer are not face-to-face during the audio/video interaction.

46. The apparatus of claim 42, wherein a device is used to obtain the storable representation of the audio/video interaction.

47. The apparatus of claim 46, wherein the device is selected from the group consisting of a video-telephone, a workstation, an audio/video monitoring system, a lap-top computer, a personal data assistant, a tablet computer and a wearable computer.

48. The apparatus of claim 43, further comprising:
a communication link to facilitate communications between the first geographic area and the second geographic area.

49. The apparatus of claim 48, wherein the communication link further comprises a satellite.

50. The apparatus of claim 42, wherein an analysis frequency applied to the agent's audio/video interactions are selected from the group consisting of at least once per day, more than once per day and a frequency sufficient to provide a statistically relevant sample of the agent's audio/video interactions.

51. The apparatus of claim 42, wherein at least one of the agent's audio/video interactions per day is analyzed for service quality.

52. The apparatus of claim 42, wherein the analysis data further comprises:
an agent performance element that could be performed even better.

53. The apparatus of claim 52, wherein the analysis data further comprises:
an agent performance element that was well performed.

54. The apparatus of claim 42, wherein the analysis data further comprises:
a training tip for the agent based on analyzing the agent's audio/video interaction.

55. The apparatus of claim 50, further comprising:
a data base comprising a plurality of analysis data based on the agent.

56. The apparatus of claim 51, further comprising:
a data base comprising a plurality of analysis data based on the agent.

57. The apparatus of claim 42, wherein the audio/video interaction further comprises a telephone call.

58. The apparatus of claim 42, wherein the audio/video interaction further comprises an email message.

59. The apparatus of claim 43, wherein the first geographic area is the United States of America and the second geographic area is selected from the group consisting of Botswana, Fiji, India, Kenya, Liberia, Nigeria, South Africa, Swaziland, Tanzania and the Philippines.

60. The apparatus of claim 43, wherein the first geographic area is the United States of America and the second geographic area is external to the United States of America.

61. The apparatus of claim 43, wherein the first geographic area is the United States of America and the second geographic area is selected from the group consisting of Argentina, Dominican Republic, Ecuador, El Salvador, Equatorial Guinea, Republic of the Congo, Mexico, Nicaragua, Panama and Uruguay.

62. The apparatus of claim 43, wherein the first geographic area is France and the second geographic area is selected from the group consisting of Algeria, Rwanda, Senegal and Haiti.

63. The apparatus of claim 42, wherein analysis of the audio/video interaction results in the transfer of a debit or a credit.

64. A method comprising:
receiving a storable representation of an audio/video interaction between an agent of a business and a customer wherein the business is located in a first geographic area;
analyzing the storable representation, in a second geographic area, to determine the service quality provided to the customer by the agent wherein the second geographic area is subject to a wage attenuator;
utilizing wage attenuation to reduce a cost of analyzing the audio/video interaction in the second geographic area relative to a cost of analyzing the audio/video interaction in the first geographic area; and
generating analysis data associated with the analyzing.

65. The method of claim 64, wherein the analyzing occurs at a frequency that requires at least one of the agent's audio/video interactions per day to be analyzed for service quality.

66. The method of claim 65, wherein the audio/video interaction further comprises data associated with the audio/video interaction.

67. The method of claim 66, further comprising:
notifying the agent of at least one agent performance element that was well performed; and
informing the agent of at least one agent performance element that could be performed even better.

68. The method of claim 67, further comprising:
providing a training tip for the agent based on the analyzing.

69. The method of claim 68, further comprising:
transferring a debit or a credit in exchange for the analyzing.

70. The method of claim 64, wherein the agent and the customer are face-to-face during the audio/video interaction.

71. The method of claim 64, wherein the agent and the customer are not face-to-face during the audio/video interaction.

72. The method of claim 64, wherein a device is used to obtain the storable representation of the audio/video interaction.

73. The method of claim 72, wherein the device is selected from the group consisting of a video-telephone, a workstation,.an audio/video monitoring system, a lap-top computer, a personal data assistant, a tablet computer and a wearable computer.

74. An apparatus comprising:
a storable representation of an audio/video interaction arising between an agent of a business and a customer, wherein the customer is in a first geographic area;
a communication link to transfer the storable representation to a second geographic area; and
a storage device coupled with the communication link, to store the storable representation wherein the storable representation is capable of being analyzed for service quality in the second geographic area by an analyst and the second geographic area subject to a geographic wage attenuator.

75. The apparatus of claim 74, wherein at least one of the agent's audio/video interactions per day is analyzed for service quality in the second geographic area.

76. The apparatus of claim 75, wherein analyzed for service quality includes scoring the agent according to predefined criteria.

77. The apparatus of claim 76, wherein predefined criteria includes scoring the agent according to criteria developed by sampling agent performance at least once a day on a substantially continuing basis.

78. The apparatus of claim 76, wherein the business is to transfer a debit or a credit in exchange for analysis of the audio/video interaction.

79. The apparatus of claim 74, wherein the agent and the customer are face-to-face during the audio/video interaction.

80. The apparatus of claim 74, wherein the agent and the customer are not face-to-face during the audio/video interaction.

81. The apparatus of claim 74, wherein a device is used to obtain the storable representation of the audio/video interaction.

82. The apparatus of claim 81, wherein the device is selected from the group consisting of a video-telephone, a workstation, an audio/video monitoring system, a lap-top computer, a personal data assistant, a tablet computer and a wearable computer.

83. A data base comprising:
analysis data corresponding to analyzed audio/video interactions between an agent and customers, wherein the agent's performance is analyzed at least once a day and analysis of the audio/video interactions proceeds on a substantially continuing basis.

84. The apparatus of claim 83, wherein analysis data further comprises:
an agent performance element that was well performed.

85. The apparatus of claim 83, wherein analysis data further comprises:
an agent performance element that could be performed even better.

86. The apparatus of claim 83, wherein analysis data further comprises:
a training tip for the agent based on analyzing the agent's interaction with a customer during an audio/video interaction.

87. A computer readable medium containing executable computer program instructions, which when executed by a data processing system, cause the data processing system to perform a method comprising:
receiving a storable representation of an audio/video interaction between an agent-of a business and a customer;
playing the storable representation to determine the service quality provided to the customer by the agent; and
generating analysis data associated with the service quality.

88. The computer readable medium of claim 87, wherein the business is located in a first geographic area and the playing occurs in a second geographic area and the second geographic area is subject to a geographic wage attenuator.

89. The computer readable medium of claim 87, wherein the agent and the customer are face-to-face during the audio/video interaction.

90. The computer readable medium of claim 87, wherein the agent and the customer are not face-to-face during the audio/video interaction.

91. The computer readable medium of claim 87, wherein a device is used to obtain the storable representation of the audio/video interaction..

92. The computer readable medium of claim 91, wherein the device is selected from the group consisting of a video-telephone, a workstation, an audio/video monitoring system, a lap-top computer, a personal data assistant, a tablet computer and a wearable computer.

93. The computer readable medium of claim 87, wherein the playing occurs at a frequency that requires at least one of the agent's audio/video interaction per day to be analyzed for service quality.

94. The computer readable medium of claim 93, wherein the audio/video interaction further comprises data associated with the audio/video interaction.

95. The computer readable medium as set forth in claim 94, the method further comprising:
notifying the agent of at least one agent performance element that was well performed; and
informing the agent of at least one agent performance element that could be performed even better.

96. The computer readable medium of claim 95, the method further comprising:
transferring a debit or a credit in exchange for analysis of the audio/video interaction.

97. An apparatus comprising:
a processor;
a reader coupled with the processor; and
a computer readable medium containing executable computer program instructions, which when executed by the apparatus, cause the apparatus to perform a method comprising:
receiving a storable representation of an audio/video interaction between an agent of a business and a customer;
playing the storable representation to determine the service quality provided to the customer by the agent; and
generating analysis data associated with the service quality.

98. The apparatus of claim 97, further comprising:
a data display configured with the processor to facilitate determining the service quality of the audio/video interaction; and
a data input device configured with the processor to accept input from an analyst, wherein the input is part of the analysis data.

99. The apparatus of claim 97, wherein the data input device is selected from the group consisting of a computer mouse, a pointing device, a keyboard, and a microphone.

100. The apparatus of claim 97, wherein the audio/video interaction further comprises data associated with the audio/video interaction.

101. The apparatus of claim 97, wherein the agent and the customer are face-to-face during the audio/video interaction.

102. The apparatus of claim 97, wherein the agent and the customer are not face-to-face during the audio/video interaction.

103. The apparatus of claim 97, wherein a device is used to obtain the storable representation of the audio/video interaction.

104. The apparatus of claim 103, wherein the device is selected from the group consisting of a video-telephone, a workstation, an audio/video monitoring system, a lap-top computer, a personal data assistant, a tablet computer and a wearable computer.
